(19) United States
(12) Patent Application Publication
(10) Pub. No.: US 2026/0105352 A1
(43) Pub. Date: Apr. 16, 2026

(54) PROACTIVE LOG-BASED MITIGATION AND REMEDIATION

(71) Applicant: INTERNATIONAL BUSINESS MACHINES CORPORATION, Armonk, NY (US)

(72) Inventors: Shweta VOHRA, Farnborough (GB); Siddhartha SOOD, Ghaziabad (IN); Madhusmita PATIL, Hyderabad (IN)

(21) Appl. No.: 18/913,451

(22) Filed: Oct. 11, 2024

(51) Int. Cl. G06N 20/00

(52) U.S. Cl. CPC G06N 20/00

(57) ABSTRACT

Computer implemented methods, systems, and computer program products include program code executing on a processor(s) which generates log files comprising records of events in a computing system (triggered by system issues). The program code converts the log files into smart log files which include remedies for the issues and execution plans by applying intelligent logging semantics derived utilizing a trained machine learning algorithm, to data comprising the log files. The program code automatically implements the remedies via the execution plans. The program code monitors and retains results of the execution plans (e.g., data relating to performance of resources of the computing system). The program code re-trains the machine learning algorithm with the results of the execution plans. The program code tunes the intelligent logging semantics with the re-trained machine learning algorithm.

### BACKGROUND

One or more aspects relate, in general, to facilitating processing within a computing environment, and in particular, to tune and implement machine learning models to utilize log data to mitigate issues and optimize efficiencies, automatically, for software executing in shared computing environments.

Logging is a technique used in software development that allows developers to see into their application's runtime processes. Logging can be used for various purposes, including performance monitoring and debugging. Logging in software applications involves recording events, errors, and other relevant information during the execution of a software application or process. Different types of logging include audit logging (for recording security-related events), performance logging (for capturing information related to an application's performance), and event logging (to record specific occurrences of events like user actions or system changes). Debug logging specifically focuses on providing information to assist in identifying and resolving bugs or defects. Capturing and storing information about the application's execution at runtime, can yield many benefits. These benefits include, but are not limited to, providing assistance in identifying root causes of issues, providing insights into how to fix an error, providing insights into how to reproduce an error, and/or identifying potential performance issues.

In addition to software performance logging, there are various types of logs that can be captured during system runtime that can be used to provide insights into computer system functionality at different layers. For example, application logs record events and activities within an application. System logs capture events and errors related to the operating system. Security logs track security-related events, such as login attempts and access control. Network logs record network-related activities and communication. Web server logs are records of requests and responses based on communications with a web server. Database logs capture database-related activities, queries, and errors. Error logs record errors and exceptions encountered by applications or systems. Audit logs track changes and activities to maintain an audit trail. Performance logs capture system or application performance metrics. Debag logs, which are arguably the most well-known type of logs, provide detailed information for debugging and troubleshooting.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided through the provision of a computer-implemented method for proactively mitigating issues. The method can include generating, by one of more processors, log files comprising records of events in computing system, wherein the events are triggered by issues in the computing system. The method can include converting, by the one or more processors, the log files into smart log files, wherein the smart log files comprise remedies for the issues and execution plans for the remedies, wherein the converting comprises applying intelligent logging semantics derived utilizing a trained machine learning algorithm, to data comprising the log files to derive data comprising the smart log files. The method can include automatically implementing, by the one or more processors, the remedies via the execution plans. The method can include monitoring and retaining, by the one or more processors, results of the execution plans, wherein the results of the execution plan comprise system data relating to performance of resources of the computing system experiencing the issues at the generating. The method can include re-training, by the one or more processors, the machine learning algorithm with the results of the execution plans. The method can also include tuning, by the one or more processors, the intelligent logging semantics with the re-trained machine learning algorithm.

Shortcomings of the prior art are overcome, and additional advantages are provided through the provision of a computer program product for proactively mitigating issues. The computer program product comprises a storage medium readable by a one or more processors and storing instructions for execution by the one or more processors for performing a method. The method includes, for instance: generating, by the one of more processors, log files comprising records of events in computing system, wherein the events are triggered by issues in the computing system. The method can include converting, by the one or more processors, the log files into smart log files, wherein the smart log files comprise remedies for the issues and execution plans for the remedies, wherein the converting comprises applying intelligent logging semantics derived utilizing a trained machine learning algorithm, to data comprising the log files to derive data comprising the smart log files. The method can include automatically implementing, by the one or more processors, the remedies via the execution plans. The method can include monitoring and retaining, by the one or more processors, results of the execution plans, wherein the results of the execution plan comprise system data relating to performance of resources of the computing system experiencing the issues at the generating. The method can include re-training, by the one or more processors, the machine learning algorithm with the results of the execution plans. The method can also include tuning, by the one or more processors, the intelligent logging semantics with the re-trained machine learning algorithm.

Shortcomings of the prior art are overcome, and additional advantages are provided through the provision of a system for proactively mitigating issue. The system includes: a memory, one or more processors in communication with the memory, and program instructions executable by the one or more processors via the memory to perform a method. The method can include generating, by the one of more processors, log files comprising records of events in computing system, wherein the events are triggered by issues in the computing system. The method can include converting, by the one or more processors, the log files into smart log files, wherein the smart log files comprise remedies for the issues and execution plans for the remedies, wherein the converting comprises applying intelligent logging semantics derived utilizing a trained machine learning algorithm, to data comprising the log files to derive data comprising the smart log files. The method can include automatically implementing, by the one or more processors, the remedies via the execution plans. The method can include monitoring and retaining, by the one or more processors, results of the execution plans, wherein the results of the execution plan comprise system data relating to performance of resources of the computing system experiencing the issues at the generating. The method can include re-training, by the one or more processors, the machine learning algorithm with the results of the execution plans. The method can also include tuning, by the one or more processors, the intelligent logging semantics with the re-trained machine learning algorithm.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is an illustration of various aspects of a self-healing framework provided in the present disclosure;

FIG. 3 is an illustration of a technical architecture where various aspects of the present disclosure have been implemented.
sample business process model (BPM) that includes various aspects of the present disclosure; and

FIG. 4 depicts a machine learning system that is an aspect of some examples of the present disclosure.

### DETAILED DESCRIPTION

The computer-implemented methods, computer program products, and systems described herein generate logs in a paradigm referred to as a self-healing log, such that these logs can be proactive instead of reactive and as such, can mitigate software and processing issues within computing environments, including but not limited to, shared computing environments such as hybrid cloud computing environments. The generation and utilization in the context described herein of self-healing logs, which can be referred to as an intelligent log semantics, includes program code (e.g., comprising agents) executing on one or more processors which aggregate actions and/or remediations in logs to be executed either locally or at global level to mitigate possible system issues as well as to maintain processing efficiencies and provide optimizations.

As understood herein, a self-healing log, which can be understood as a smart log, is a log file that contains both traditional log information, data that reports aspects of an event that occurred, but also includes information that can be used to automate a response. This information can include a recommendation, an action item, etc., responsive and/or to mitigate the event being reported in the log, also referred to herein as a remedy. For example, while a log in an existing or traditional system may include an error message, a timestamp, and an error code or impact-related data, the examples herein can produce logs that include, but are not limited to, action, remedy, confidence threshold, and an automated command to address the issue. The smart logs or self-healing logs produced by program code in the examples herein can also designate whether a global or local resource should execute the remedy provided in the log.

In some examples, the agents can classify actions and/or remediations based on determining priority within a pre-determined confidence level (e.g., an initial confidence factor). Remediations performed by the program code can include, but are not limited to, automatically addressing an issue revealed in the logs and/or ceasing generation of certain logs. In some examples, the program code generates a recommended action or remedy or remediation either locally or globally; the program code identifies in advance of and/or contemporaneously with generating the recommendation whether the recommendation can be generated locally or whether the recommendation needs additional context from global agents. The program code can also generate a remedy and include data in the log indicating that the remedy should be executed at a local or global level. The program code can also balance the impact of actions and/or remediations before implementing them, performing a cost/benefit analysis. For example, the program code can continuously collect, observe, and balance data related to the effects of applying actions and remediations in the self-healing of logs on the computer system.

In some examples, the program code utilizes the confidence level (e.g., an initial confidence factor) associated with a recommendation to make determine whether a remedy should be executed and when (e.g., regarding an action to mitigate an issue, improve system performance, etc.). In some examples, the program code comprises smart probes which can generate semantics and build or modify existing semantics. The program code comprising these probes (machine) learns from insights into system behavior, and can identify patterns and/or bottlenecks, and can assist in propagating a change to address issues related to the identified patterns and/or bottlenecks helping propagate the change. The program code can learn from these observed and healed log patterns, creating a feedback loop to continuously train semantics and contexts (e.g., machine learning model) applied by the program code when generating self-healing or smart logs.

The examples herein can also provide transparency to users. For example, the program code can customize the analytics for each customer and provide visibility to the self-learning and healing logging system. These analytics can be utilized as training data in the aforementioned feedback loop.

Increasingly, users access software systems in shared computing environments, including but not limited to cloud computing environments like hybrid multi-cloud worlds. Logs and telemetry produced by these systems, because of the vastness of the enterprise solutions and the diversity of the client services, can be so voluminous that present log analysis systems cannot handle these data. Meanwhile, the efficacy (usefulness) of a software solution, in general, is arguably tied to whether purpose-based logging, utilization, and the log quality can be utilized so that the user can meet objectives.

Usage of present logging tools to mitigate issues with software and improve overall performance (including other processing-related benefits) can be complicated by the reactive approach of these tools. When logs are voluminous, gaining useful information from which to manually develop an approach to address any issues based on analyzing this information can consume times and resources to the point that it becomes ineffective. The existing plethora of tools associated log aggregation, management, and events handling take this reactive approach to telemetry, focusing on after-the-fact analysis rather than proactive purpose-built logs and their utilization at the appropriate time and in the appropriate context. Even a medium-sized e-commerce platform where logs capturing user interactions, transactions, and system events might accumulate around 100 gigabytes to 1 terabyte (or more) of data daily, reflecting the diverse range of activities. Within a healthcare application, the logs pertaining to patient records, including medical events, and system integrations, could span between 50 gigabytes to 500 gigabytes. Parsing these logs in a reasonable amount of time and determining how to react to these logs with a time and context that can mitigate issues can challenge processing resources.

As noted above, existing approaches to utilizing logs to improve software and overall system experience, performance, and processing efficiencies within a shared computing environment are reactive as opposed to proactive. These reactive approaches become less and less useful as more users move to enterprise solutions in shared computing environments, such as cloud computing environments (including hybrid environments) because the quantity of logs generated by the diverse offerings executing in these environments is growing exponentially and becoming inefficient to parse. Thus, by the time log analytics provide intelligence that could be used to adjust a software implementation or configuration, the need for the change has passed as the implementation and/or the configuration may have already changed. Thus, an approach that is timely and resource efficient is needed to optimize software execution within these computing environments.

The examples herein represent a paradigm shift that is directed to a practical application (e.g., efficiently processing logs in a shared computing environment to improve processing) and provides significantly more than existing approaches. The examples herein shift from existing approaches, which are reactive log handling methods, towards a proactive method that generates logs that provide valuable insights to the program code, including remedies to issues reported in the same logs, when needed. Specifically, in the examples herein, the computing system can be understood as self-healing logs as they report an issue and also, a potential remedy. Existing approaches create a dependency chain from birth of software application lifecycle to the end and in between which is eliminated in the examples herein, positively impacting system (and software) performance.

The examples described herein provide significantly more than present logging procedures at least by eliminating specific computing issues experienced when utilizing the existing approaches. First, the examples herein manage the quantity of logs produced in a constructive manner by enabling certain sets of logs and telemetry. Shared environments (e.g., hybrid cloud environments) can produce logs at various levels: infrastructure, application, cloud services, distributed traces, network, failures, threshold-based, etc. and the examples herein enable only certain of these logs for self-healing. Second, aspects of the examples herein address the negative impacts of reactive usage and filtering of logs by implementing a proactive method. Third, the examples herein address the issue in current approaches of a lack of usefulness of many of the log sources (e.g., infrastructure, DB, Application, networking, services, AIOps, FinOps, etc.) to certain situations by self-optimizing certain relevant logs. Fourth, in present approaches high volume logs take large processing and memory capacity while the more restrained log usages described herein utilize resources more efficiently. Fifth, the quantity of logs in existing shared computing environments, when parsed by existing approaches require heavy weight centralized or distributed logging mechanisms, log retention costs, and solutions to recover logs faster within performance limits, while the existing approach is more efficient and can operate within the metes and bounds of the system resources without the need for these additions. Finally, log resolution and automation in existing systems (e.g., predicting, detecting, alerting, resolving, and reporting errors and/or exceptions) is costly from a processing standpoint while the examples herein can be accomplished without these costs.

The examples herein are inextricably tied to computing and, as aforementioned, directed to a practical purpose. They are inextricably tied to computing at least because the examples herein address an issue that is unique to computing, optimizing software performance through the use of logs, for a purpose that is inextricably tied to computing, improving processing and performance in a computing environment. As discussed herein, although aspects of the examples can be utilized across various computing environments, the aspects can be particularly useful in the management and maintenance of shared computing environments, such as hybrid cloud computing environments. The examples herein provide a unique approach to log generation and life-cycle management that leverages a paradigm shift by providing proactive logging, including self-healing or smart logs.

The examples herein are also inextricably tied to computing based on utilizing machine learning models as part of the paradigm. In these examples, the program code develops and trains machine learning models, including with underlying recurrent neural networks (RNNs) and/or convolutional neural network (CNNs), to generate self-healing logs (logs that themselves can automatically address issues the logs would reveal), to take actions in computing systems (including in enterprise computing systems). The program code continuously updates and refines the model to improve accuracy and efficiency. As will be discussed herein, the program code generates, refines, and continuously tunes intelligent logging semantics which are utilized by the program code to generate the self-healing logs.

Neural networks, which are utilized in certain of the examples herein, refer to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex data sets, neural networks and deep learning provide solutions to many problems in image recognition, speech recognition, and natural language processing. Neural networks can model complex relationships between inputs and outputs to identify patterns in data, including in images, for classification. For this reason, machine learning models in the examples herein can utilize neural networks to generate self-healing logs.

In certain embodiments of the present invention the program code utilizes a CNN. CNNs are so named because they utilize convolutional layers that apply a convolution operation (a mathematical operation on two functions to produce a third function that expresses how the shape of one is modified by the other) to the input, passing the result to the next layer. The convolution emulates the response of an individual neuron to visual stimuli. Each convolutional neuron processes data only for its receptive field. It is generally not practical to utilize general (i.e., fully connected feedforward) neural networks to process data rich objects, as very high number of neurons would be necessary, due to the very large input sizes associated with larger files. Utilizing a CNN addresses this issue as it reduces the number of free parameters, allowing the network to be deeper with fewer parameters, as regardless of the file size, the CNN can utilize a consistent number of learnable parameters because CNNs fine-tune large amounts of parameters and massive pre-labeled datasets to support a learning process. CNNs resolve the vanishing or exploding gradients problem in training traditional multi-layer neural networks, with many layers, by using backpropagation. Thus, CNNs can be utilized in large-scale recognition systems, giving state-of-the-art results in segmentation, object detection, and object retrieval. Semantic recognition is an example of large-scale recognition in which a CNN can be utilized by the program code.

In certain embodiments of the present invention the program code utilizes an RNN. An RNN is a class of NN where connections between units form a directed cycle to exhibit dynamic temporal behavior. Unlike feedforward NNs, RNNs can use their internal memory to process arbitrary sequences of inputs. For this reason, current applications of RNNs include unsegmented data recognition, connected handwriting recognition, and speech recognition. Given that LLMs can receive speech as well as natural language in other formats (e.g., text), including via a chatbot, an RNN can be utilized in various examples herein. RNNs can also be utilized to analyze logs, which can have a specialized language or pattern.

The examples herein include computer-implemented methods, computer program products, and computer systems for proactively mitigating issues. In an example of a computer-implemented method, program code executing on one or more processors generates log files comprising records of events in computing system. The events are triggered by issues in the computing system. Program code converts the log files into smart log files; the smart log files comprise remedies for the issues and execution plans for the remedies. This converting aspect includes applying intelligent logging semantics derived utilizing a trained machine learning algorithm, to data comprising the log files to derive data comprising the smart log files. The program code automatically implements the remedies via the execution plans. The program code monitors and retains results of the execution plans. The results of the execution plan comprise system data relating to performance of resources of the computing system experiencing the issues at the generating. The program code re-trains the machine learning algorithm with the results of the execution plans. The program code tunes the intelligent logging semantics with the re-trained machine learning algorithm. Implementation of this example in a computing environment benefits the computing environment as a whole because it converts logging into a proactive approach to system optimization and performance maintenance as opposed to the reactive approach of current logging systems. By generating a log, the program code can automatically address the issue indicated in the log, which can improve system performance.

In some examples, when the program code tunes the intelligent logging semantics, the program code expands the intelligent logging semantics to include additional fields. This aspect provides a benefit to the computing system at least because as a computing system into which these aspects are implemented changes over time (and services can change regularly in multi-user systems), the program code can adapt to these changes and implement remedies that ensure processing continuity within the system in concert with the elasticity of the system.

In some examples, when the program code automatically implements the remedies via the execution plans, for each execution plan, the program code determines whether to execute a remedy of the remedies for an issue of the issues on a local resource from which the issue originated or at a global computing system resource. The determining comprising the program code identifying a smart log of the smart logs, when the smart log is related to the issue. The program code triggers execution of the remedy based on the smart log. The implementation of this example in a computing system provides a benefit to the computing environment as least because in a shared computing environment, issues that are logged can impact processing locally and/or globally and the granularity utilized when addressing these issues can impact the success of the remedy and its impacts of the system, as a whole. This flexibility enables the program code to automatically resolve issues with a level of granularity that optimized operations without disrupting other system processes.

In some examples, the program code monitoring the results of the execution plans includes the program code obtaining the results of the execution plans from local agents monitoring designated resource clusters comprising the computing system and from global agents monitoring the computing system. This aspect provides a benefit of enabling continuous improvement to the self-learning logs. As the system changes, the logs can improve to provide the same processing benefits.

In some examples, the program code applying intelligent logging semantics comprises the program code determining, for each execution plan of the execution plan, whether applying each remedy of the remedies involves a local execution or a global execution of the remedy. The program code makes this determination by determining, based on the intelligent logging semantics, if the executing the remedy utilizes additional context from the global agents. Based on determining that the executing the remedy utilizes additional context from the global agents, the program code designates a global execution of the remedy in the smart logs. This aspect provides a benefit to the computing system because although an issue recorded in a log can indicate a local issue, as computing systems expand into shared multi-user environments, applying a remedy that addresses a perceived issue could have unintended consequences for other parts of the system. This aspect flags an issue as benefitting from additional context so the impacts of addressing the issue with a given remedy are realized and a remedy is applied with context that optimizes its change at a positive benefit.

In some examples, the program code applying intelligent logging semantics includes the program code determining, for each execution plan of the execution plan, whether applying each remedy of the remedies involves a local execution or a global execution of the remedy. The program code makes this determination by determining, based on the intelligent logging semantics, if the executing the remedy utilizes additional context from the global agents. Based on determining that the executing the remedy does not utilize additional context from the global agents, the program code designates a local execution of the remedy in the smart logs. This aspect flags an issue as being resolvable without additional context so a remedy can be applied. This check assists in recognizing items that may have unintentional impacts and resolving issues promptly that do not fall into that category, maintaining or increasing issue resolution efficiencies within a computing system.

In some examples, when the program code automatically implements the remedies via the execution plans, for each execution plan, the program code determines whether implementing the remedy comprises executing the execution plan or ignoring the execution plan. The program code predicts, based on historical data, impacts on the computing system of executing the execution plan. The program code balances the predicted impacts against a current state of the computing system. Based on making this determination (based on the balancing), when the program code predicts impacts are favorable, the program code executes the execution plan. When the program code determines, based on the balancing, that the current state is favorable, the program code ignores the execution plan. This aspects increases the efficiency of the computing system by providing a fill view of the impacts of resolving an issue. The program code provides a remedy in a log for a the logged issue but because computing systems are expansive, applying a remedy to an issue could disrupt processing overall despite improving a given aspect. Thus, this aspect benefits the computing system by balancing addressing a given issue with ignoring that issue and maintaining the status quo. When addressing the issue would more adversely impact processing than maintaining the status quo, the status quo is more favorable and thus, the program code maintains the efficiency of the system by including this balancing aspect.

In some examples, the program code analyzes the results of the execution plans, to produce computing system analytics. The program code generates reports based on the analytics. The program code transmits the reports to an administrator of the computing system. This aspect provides a benefit to the computing system as it increases system transparency.

In some examples, the program code re-training the machine learning algorithm comprises the program code providing the analytics as an input to the machine learning algorithm. This aspect improved the computing system into which it is implemented by adding flexibility to the machine learning algorithm such that it can adapt to changes within the computing system and implement these changes into the proactive approach for remedying logged issues.

In some examples, the monitoring and the retaining are performed by the program code based on controlling probes. This aspect benefits the program code based on providing data from various layers and/or levels of the computing system. The depth of the data provided enables optimization and improvement to processing as a whole.

In some examples, the program code provides to clusters comprising the computing environment, environment-specific services, via the probes. This aspect provides benefits to the computing system by customizing resolutions to issues reported by the logs in order to maintain processing efficiency.

Some examples include a computer system for proactively mitigating issues, that includes a memory one or more processors in communication with the memory, where the computer system is configured to perform a method. The method can include program code executing on one or more processors generates log files comprising records of events in computing system. The events are triggered by issues in the computing system. Program code converts the log files into smart log files; the smart log files comprise remedies for the issues and execution plans for the remedies. This converting aspect includes applying intelligent logging semantics derived utilizing a trained machine learning algorithm, to data comprising the log files to derive data comprising the smart log files. The program code automatically implements the remedies via the execution plans. The program code monitors and retains results of the execution plans. The results of the execution plan comprise system data relating to performance of resources of the computing system experiencing the issues at the generating. The program code re-trains the machine learning algorithm with the results of the execution plans. The program code tunes the intelligent logging semantics with the re-trained machine learning algorithm. Implementation of this example in a computing environment benefits the computing environment as a whole because it converts logging into a proactive approach to system optimization and performance maintenance as opposed to the reactive approach of current logging systems. By generating a log, the program code can automatically address the issue indicated in the log, which can improve system performance.

In some examples of the system, when the program code tunes the intelligent logging semantics, the program code expands the intelligent logging semantics to include additional fields. This aspect provides a benefit to the computing system at least because as a computing system into which these aspects are implemented changes over time (and services can change regularly in multi-user systems), the program code can adapt to these changes and implement remedies that ensure processing continuity within the system in concert with the elasticity of the system.

In some examples of the system, when the program code automatically implements the remedies via the execution plans, for each execution plan, the program code determines whether to execute a remedy of the remedies for an issue of the issues on a local resource from which the issue originated or at a global computing system resource. The determining comprising the program code identifying a smart log of the smart logs, when the smart log is related to the issue. The program code triggers execution of the remedy based on the smart log. The implementation of this example in a computing system provides a benefit to the computing environment as least because in a shared computing environment, issues that are logged can impact processing locally and/or globally and the granularity utilized when addressing these issues can impact the success of the remedy and its impacts of the system, as a whole. This flexibility enables the program code to automatically resolve issues with a level of granularity that optimized operations without disrupting other system processes.

In some examples of the system, the program code monitoring the results of the execution plans includes the program code obtaining the results of the execution plans from local agents monitoring designated resource clusters comprising the computing system and from global agents monitoring the computing system. This aspect provides a benefit of enabling continuous improvement to the self-learning logs. As the system changes, the logs can improve to provide the same processing benefits.

In some examples of the system, the program code applying intelligent logging semantics comprises the program code determining, for each execution plan of the execution plan, whether applying each remedy of the remedies involves a local execution or a global execution of the remedy. The program code makes this determination by determining, based on the intelligent logging semantics, if the executing the remedy utilizes additional context from the global agents. Based on determining that the executing the remedy utilizes additional context from the global agents, the program code designates a global execution of the remedy in the smart logs. This aspect provides a benefit to the computing system because although an issue recorded in a log can indicate a local issue, as computing systems expand into shared multi-user environments, applying a remedy that addresses a perceived issue could have unintended consequences for other parts of the system. This aspect flags an issue as benefitting from additional context so the impacts of addressing the issue with a given remedy are realized and a remedy is applied with context that optimizes its change at a positive benefit.

In some examples of the system, the program code applying intelligent logging semantics includes the program code determining, for each execution plan of the execution plan, whether applying each remedy of the remedies involves a local execution or a global execution of the remedy. The program code makes this determination by determining, based on the intelligent logging semantics, if the executing the remedy utilizes additional context from the global agents. Based on determining that the executing the remedy does not utilize additional context from the global agents, the program code designates a local execution of the remedy in the smart logs. This aspect flags an issue as being resolvable without additional context so a remedy can be applied. This check assists in recognizing items that may have unintentional impacts and resolving issues promptly that do not fall into that category, maintaining or increasing issue resolution efficiencies within a computing system.

In some examples of the system, when the program code automatically implements the remedies via the execution plans, for each execution plan, the program code determines whether implementing the remedy comprises executing the execution plan or ignoring the execution plan. The program code predicts, based on historical data, impacts on the computing system of executing the execution plan. The program code balances the predicted impacts against a current state of the computing system. Based on making this determination (based on the balancing), when the program code predicts impacts are favorable, the program code executes the execution plan. When the program code determines, based on the balancing, that the current state is favorable, the program code ignores the execution plan. This aspects increases the efficiency of the computing system by providing a fill view of the impacts of resolving an issue. The program code provides a remedy in a log for a the logged issue but because computing systems are expansive, applying a remedy to an issue could disrupt processing overall despite improving a given aspect. Thus, this aspect benefits the computing system by balancing addressing a given issue with ignoring that issue and maintaining the status quo. When addressing the issue would more adversely impact processing than maintaining the status quo, the status quo is more favorable and thus, the program code maintains the efficiency of the system by including this balancing aspect.

In some examples of the system, the program code analyzes the results of the execution plans, to produce computing system analytics. The program code generates reports based on the analytics. The program code transmits the reports to an administrator of the computing system. This aspect provides a benefit to the computing system as it increases system transparency.

In some examples of the system, the program code re-training the machine learning algorithm comprises the program code providing the analytics as an input to the machine learning algorithm. This aspect improved the computing system into which it is implemented by adding flexibility to the machine learning algorithm such that it can adapt to changes within the computing system and implement these changes into the proactive approach for remedying logged issues.

In some examples of the system, the monitoring and the retaining are performed by the program code based on controlling probes. This aspect benefits the program code based on providing data from various layers and/or levels of the computing system. The depth of the data provided enables optimization and improvement to processing as a whole.

In some examples of the system, the program code provides to clusters comprising the computing environment, environment-specific services, via the probes. This aspect provides benefits to the computing system by customizing resolutions to issues reported by the logs in order to maintain processing efficiency.

Some examples include a computer program product for proactively mitigating issues. The computer program product can include one or more computer readable storage media and program instructions collectively stored on the one or more computer readable storage media readable by at least one processing circuit to generate log files comprising records of events in computing system. The events are triggered by issues in the computing system. Program instructions convert the log files into smart log files; the smart log files comprise remedies for the issues and execution plans for the remedies. This converting aspect includes applying intelligent logging semantics derived utilizing a trained machine learning algorithm, to data comprising the log files to derive data comprising the smart log files. The program instructions automatically implement the remedies via the execution plans. The program instructions monitor and retain results of the execution plans. The results of the execution plan comprise system data relating to performance of resources of the computing system experiencing the issues at the generating. The program instructions re-train the machine learning algorithm with the results of the execution plans. The program instructions tune the intelligent logging semantics with the re-trained machine learning algorithm. Implementation of this example in a computing environment benefits the computing environment as a whole because it converts logging into a proactive approach to system optimization and performance maintenance as opposed to the reactive approach of current logging systems. By generating a log, the program instructions can automatically address the issue indicated in the log, which can improve system performance.

In some examples of the computer program product, when the program instructions tune the intelligent logging semantics, the program instructions expand the intelligent logging semantics to include additional fields. This aspect provides a benefit to the computing system at least because as a computing system into which these aspects are implemented changes over time (and services can change regularly in multi-user systems), the program instructions can adapt to these changes and implement remedies that ensure processing continuity within the system in concert with the elasticity of the system.

In some examples of the computer program product, when the program instructions automatically implement the remedies via the execution plans, for each execution plan, the program instructions determine whether to execute a remedy of the remedies for an issue of the issues on a local resource from which the issue originated or at a global computing system resource. The determining comprising the program instructions identifying a smart log of the smart logs, when the smart log is related to the issue. The program instructions trigger execution of the remedy based on the smart log. The implementation of this example in a computing system provides a benefit to the computing environment as least because in a shared computing environment, issues that are logged can impact processing locally and/or globally and the granularity utilized when addressing these issues can impact the success of the remedy and its impacts of the system, as a whole. This flexibility enables the program instructions to automatically resolve issues with a level of granularity that optimized operations without disrupting other system processes.

In some examples of the computer program product, the program instructions monitoring the results of the execution plans includes the program instructions obtaining the results of the execution plans from local agents monitoring designated resource clusters comprising the computing system and from global agents monitoring the computing system. This aspect provides a benefit of enabling continuous improvement to the self-learning logs. As the system changes, the logs can improve to provide the same processing benefits.

In some examples of the computer program product, the program instructions applying intelligent logging semantics comprises the program instructions determining, for each execution plan of the execution plan, whether applying each remedy of the remedies involves a local execution or a global execution of the remedy. The program instructions make this determination by determining, based on the intelligent logging semantics, if the executing the remedy utilizes additional context from the global agents. Based on determining that the executing the remedy utilizes additional context from the global agents, the program instructions designate a global execution of the remedy in the smart logs. This aspect provides a benefit to the computing system because although an issue recorded in a log can indicate a local issue, as computing systems expand into shared multi-user environments, applying a remedy that addresses a perceived issue could have unintended consequences for other parts of the system. This aspect flags an issue as benefitting from additional context so the impacts of addressing the issue with a given remedy are realized and a remedy is applied with context that optimizes its change at a positive benefit.

In some examples of the computer program product, the program instructions applying intelligent logging semantics includes the program instructions determining, for each execution plan of the execution plan, whether applying each remedy of the remedies involves a local execution or a global execution of the remedy. The program instructions make this determination by determining, based on the intelligent logging semantics, if the executing the remedy utilizes additional context from the global agents. Based on determining that the executing the remedy does not utilize additional context from the global agents, the program instructions designate a local execution of the remedy in the smart logs. This aspect flags an issue as being resolvable without additional context so a remedy can be applied. This check assists in recognizing items that may have unintentional impacts and resolving issues promptly that do not fall into that category, maintaining or increasing issue resolution efficiencies within a computing system.

In some examples of the computer program product, when the program instructions automatically implement the remedies via the execution plans, for each execution plan, the program instructions determine whether implementing the remedy comprises executing the execution plan or ignoring the execution plan. The program instructions predict, based on historical data, impacts on the computing system of executing the execution plan. The program instructions balance the predicted impacts against a current state of the computing system. Based on making this determination (based on the balancing), when the program instructions predict impacts are favorable, the program instructions execute the execution plan. When the program instructions determine, based on the balancing, that the current state is favorable, the program instructions ignore the execution plan. This aspect increases the efficiency of the computing system by providing a full view of the impacts of resolving an issue. The program instructions provide a remedy in a log for the logged issue but because computing systems are expansive, applying a remedy to an issue could disrupt processing overall despite improving a given aspect. Thus, this aspect benefits the computing system by balancing addressing a given issue with ignoring that issue and maintaining the status quo. When addressing the issue would more adversely impact processing than maintaining the status quo, the status quo is more favorable and thus, the program instructions maintain the efficiency of the system by including this balancing aspect.

In some examples of the computer program product, the program instructions analyze the results of the execution plans, to produce computing system analytics. The program instructions generate reports based on the analytics. The program instructions transmit the reports to an administrator of the computing system. This aspect provides a benefit to the computing system as it increases system transparency.

In some examples of the computer program product, the program instructions re-training the machine learning algorithm comprises the program instructions providing the analytics as an input to the machine learning algorithm. This aspect improved the computing system into which it is implemented by adding flexibility to the machine learning algorithm such that it can adapt to changes within the computing system and implement these changes into the proactive approach for remedying logged issues.

In some examples of the computer program product, the monitoring and the retaining are performed by the program instructions based on controlling probes. This aspect benefits the program instructions based on providing data from various layers and/or levels of the computing system. The depth of the data provided enables optimization and improvement to processing as a whole.

In some examples of the computer program product, the program instructions provide to clusters comprising the computing environment, environment-specific services, via the probes. This aspect provides benefits to the computing system by customizing resolutions to issues reported by the logs in order to maintain processing efficiency.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

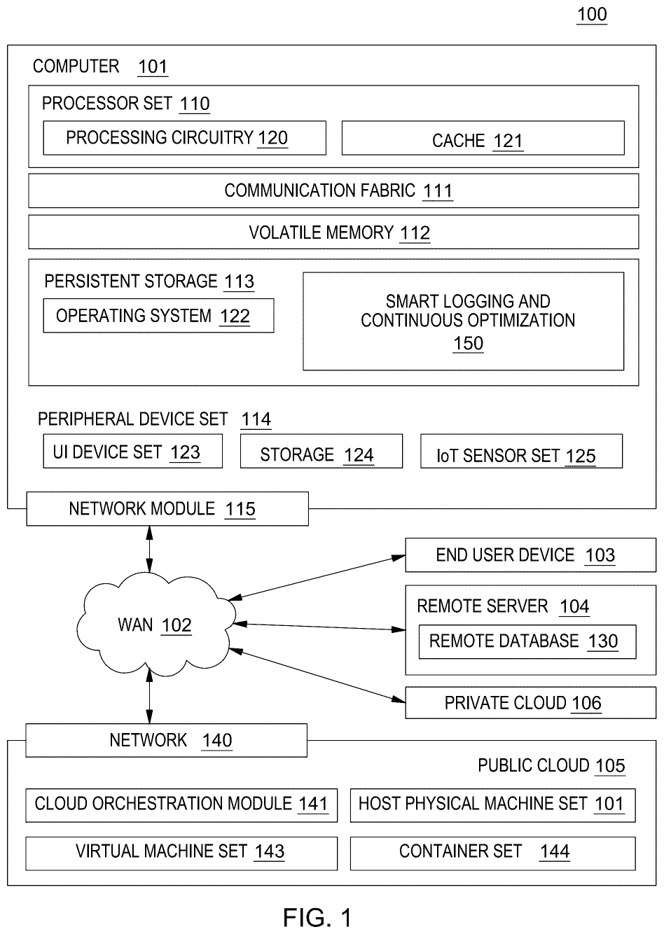

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for smart logging and continuous optimization of the computing system 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The examples herein include computer-implemented methods, computer program products, and computer systems where program code executing on one or more processors enriches logs to enable self-healing through instrumented logs. These examples represent a departure from the reactive logging paradigm of existing approaches. As standard lifecycle for log management in existing approaches can include, log generation, log collection, log storage, log processing, log indexing, log analysis, alerting (based on the analysis), visualization and reporting (based on the analysis), log archiving, log rotation, log retention, and log compliance. The examples herein eliminate many of these steps by generating logs that self-heal system issues and optimize the computing system (e.g., including software) continuously. Advantages of the examples herein include efficiency (streamlining of repetitive tasks), consistency (self-healing reduces error exposures), scalability (the machine learning of the program code enables handling of increased workloads), resource efficiency (allocation is optimized, positively impacting processing and storage), risk reduction (automating processing and implementing pre-defined rules reduces exposure based on human error).

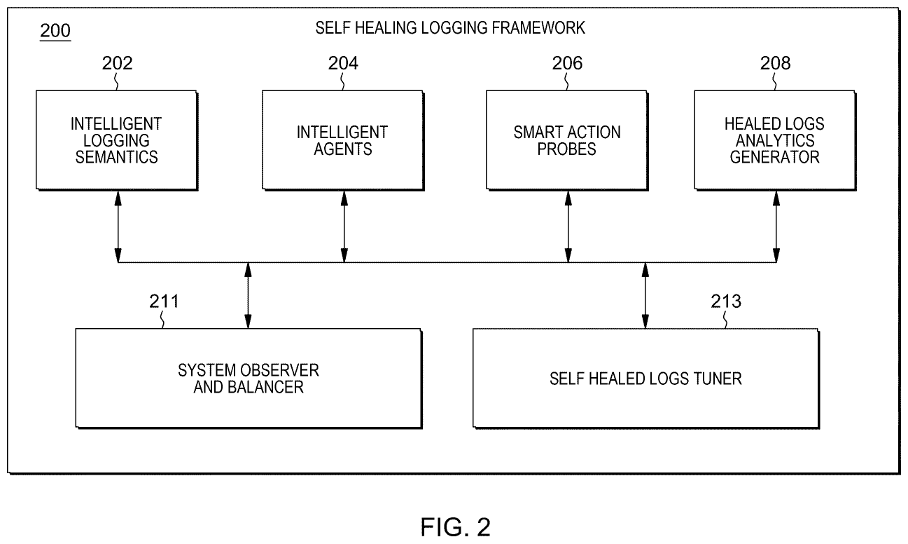

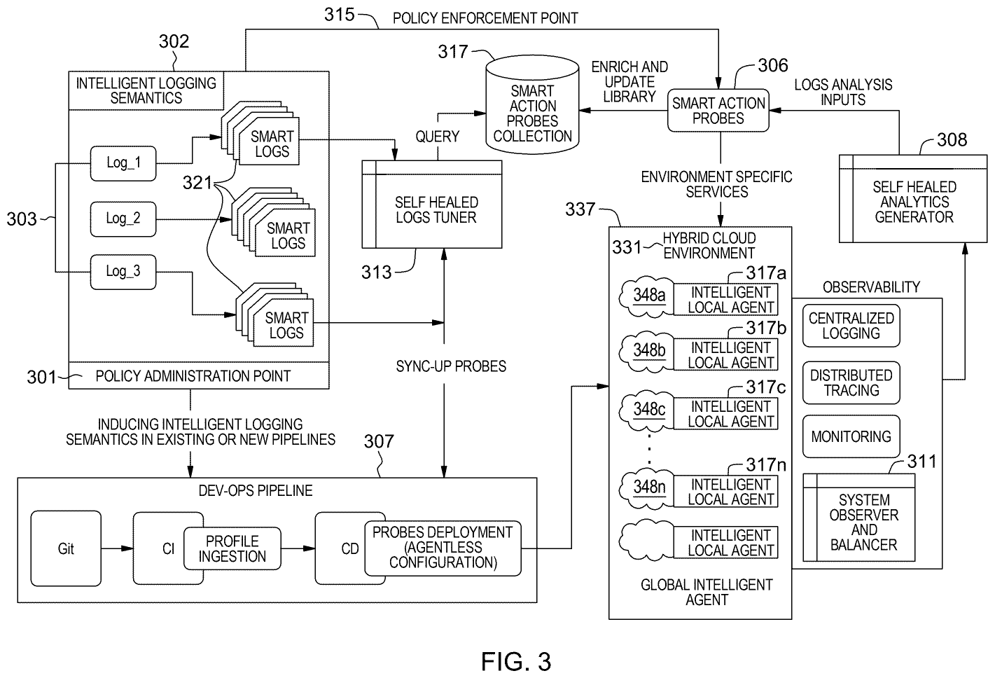

FIG. 2 illustrates various aspects of a self-healing framework 200 provided in some examples herein. Although various functionalities of the framework 200 are depicted as separate modules, this configuration is provided for illustrative purposes only and does not suggest any limitations. Separating the functionality in this manner is for ease of understanding. Additionally, certain of the functionality can be implemented without other aspects depending on the configuration choices of an administrator. The framework 200 comprises program code executing on one or more processors that achieves self-logging and continuous optimization of the computing system in which the framework 200 (or certain aspects of the framework 200) are implemented. As represented in FIG. 2, the various aspects of the framework 200 can work in concert to optimize the system into which they are implemented. Program code comprising intelligent logging semantics 202 redefines existing logging mechanisms for existing and new logs definition by providing an initial log handling, rather than handling logs at the end of a workflow, which is the existing approach. Program code comprising intelligent agents 204 assists logs that cannot self-heal by providing one or more of context or of access to enable self-healing. For example, the program code of the intelligent agents can provide a local and/or global aggregation and decision-making capability. Program code comprising smart action probes 206 enables (machine) learning by assisting in defining and redefining the intelligent logging semantics 202. Program code comprising a system observer and balancer 211 provides a decision-making capability within the examples herein by applying an analysis that weighs (e.g., balances) actions and observations within this intelligent logging system based on observing the impacts of log self-healing actions as well and, in some examples, also based on correlating past issues with remediation approaches and results. In situations where this program code determines that a recommended action would have undesired impacts that outweigh benefit (e.g., based on past actions) the program code can revise the recommended action and/or otherwise change the action to prevent the undesired outcome. Program code comprising a self-healed logs tuner 213 acts as a bridge between logging semantics enhancement and performance of continuous corrections and/or updates in the system. This aspect is described in greater detail in reference to FIG. 3. Finally, program code comprising a healed log analytics and actions generator 208 assists in implementing log self-healing actions and (machine) learned information to provide insights and automation enhancements.

As discussed above, the examples herein generate self-healing logs, which rather than exclusively report attributes of an issue (e.g., error message, timestamp and error code or impact), comprise automated commands to address the issue. As a non-limiting example, a traditional log is provided:
[Timestamp] security: [Message] Failed login attempt IP 192.168.1.100 for user ‘admin’: [Effect] Login denied.

An example of a self-healing log can take a format such as:
[Timestamp] security: [Message] Failed login attempt from IP 192.168.1.100 for user ‘admin’: Login denied: [Action] monitoring [Remedy]: Block IP in Network Control List OR Block IP in WAF [Threshold]: 5 [RunAutomation]: RunAutomationSecurity.

The traditional log example includes an error message, timestamp and error code or impact, while the self-healing log can also include the following attributes: action, remedy, threshold, remedy, threshold (confidence), and run automation. As illustrated in FIG. 2, program code executing on one or more processors can utilize intelligent logging semantics 202 to generate self-healing logs. Table 1 provides an example of semantics that can be utilized by the program code to determine whether to enable the self-healing of a log entry (e.g., whether the remedy will implemented). The intelligent logging semantics 202 in the table (which are generated by the program code), and updated by the smart action probes 206, are utilized by the program code to evaluate whether to take the automated mitigation action in the (self-healing) log.

TABLE 1
Self-Heal Log Semantics

Remedy: Ignore or aggregate or task
Threshold: 10
RunAutomation: Y
ConvertLogIntoCount: 10
Agent: Local or Global etc.
Confidence: a derived value between 0 and 1

When program code obtains a log in the examples herein, it utilizes semantics, which are continuously updated by the program code and can be stored in a memory accessible to the program code, to determine whether to automatically execute a mitigation action (including whether another module should automatically execute the mitigation action). In this example, the semantics include Remedy, Threshold, RunAutomation, ConvertLogIntoCount, Agent, and Confidence. This is a non-limiting example that is provided for illustrative purposes only. The semantics establish Remedy values of ignore, aggregate, or task. These are actions that can be executed by the program code to address the issue in the log. The Threshold in this example is a preconfigured value that when reached (by a log record), triggers program code to implement the remedy. RunAutomation is a binary value that can indicate to the program code whether a given remedy should be implemented automatically by the program code or not, and in some examples, how the automation should be implemented. If there is not an automated run, the program code can regard the remedy as a recommendation and could provide it, though a graphical user interface (GUI) and/or report to the user as such. ConvertLogIntoCount, which is a threshold value, can trigger the program code to perform the remedy (e.g., to heal) if the count in the log record has reached this pre-configured threshold. The Agent field can be a binary choice, local or global, and can indicate whether the remedy should be executed locally (to the source of the log) or if additional context from global agents can be utilized (in this example) to execute the remedy. In some examples, intelligent agents can provide a local and/or global aggregation and decision-making capability. Confidence, which is derived by the program code, in this example, is a derived value between 0 and 1 and is an initial confidence factor associated with the remedy can be used by the program code to determine whether to implement the remedy (e.g., part of a cost benefit analysis performed by the program code in some examples).

The self-healing logs generated by the program code, and utilized recommend remedial actions, and to automatically implement remedial actions (or to determine whether to implement these remedial actions), can be implemented into various logging practices within a computing system. Although various examples are provided with improving software performance in mind, aspects of the examples herein can be implemented to enhance various logging systems to convert these systems such that the systems produce self-healing (e.g., smart) logs. Hence, a non-limiting list of logs into which the aspects described herein can be implemented include, application logs, system logs, security logs, network logs, web server logs, database logs, error logs, audit logs, performance logs, and/or debug logs. Thus, although certain examples herein refer to utilizing the aspects described in improving and maintaining software performance, the examples herein can also be implemented to improve and main performance and efficiencies in various layers or levels of a technical environment.

In the examples herein, program code executing on one or more processors generates logs instrumented with healing information to enable a paradigm shift to a self-healing logging system capability. Thus, program code in the examples herein provides source data and passes this source data through various feedback processes to build instrumentation for the self-healing functionality. FIG. 3 is a technical architecture 300 where various aspects of the examples herein have been implemented. In this example, at a policy administration point 301 in the technical architecture 300, program code obtains log files (log_1, log_2, log_3), and utilizing the intelligent logging semantics 302, enhances the data to generate smart logs 321. The program code provides smart logs 321 to the self-healed logs tuner 313 and to a policy enforcement point 315 in the technical environment 310, which includes the smart action probes 306. The smart action probes 306 enable machine learning and help redefine and refine logging semantics 302 and as part of this functionality, program code retains data from the smart action probes 306 in a computing resource, such as a database or memory, referred to in FIG. 3 as a smart action probes collection 317. Smart action probes 306 can provide environment-specific services to the shared computing environment, which in this example, is a hybrid cloud environment 331.

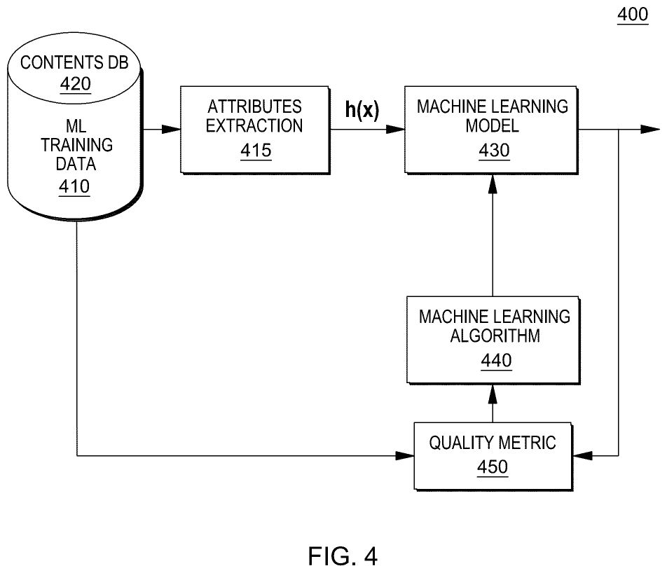

FIG. 4 is one example of a machine learning system 400 (which is responsible for assisting in the tuning performed by the self-healed logs tuner 313, based on machine learning performed by the smart action probes 306, including the data collected by these probes (e.g., smart action probes collection 317), that can be utilized, in one or more aspects, to perform analyses of various data related to the processes in the hybrid cloud environment 331, and the results of remedies in the smart logs 321 (generated utilizing the intelligent logging semantics 302), including but not limited to data obtained by monitoring the process-in-progress (e.g., by the system observer and balancer 311).

Machine learning (ML) solves problems that are not solved with numerical means alone. In this ML-based example, program code extracts various attributes (415) from data obtained from devices monitoring the execution of the remedies in the self-healing logs generated by the program code, and the logs generated after the remedies are applied, including the log analysis inputs provided by the self-healed analytics generator 308. The program code can utilize these attributes to develop a predictor function, h(x), also referred to as a hypothesis, which the program code utilizes as a machine learning model 430, in this case, to anticipate whether certain remedies in the logs, when applied will achieve a desired result (the result being extending from the functionality of the application or layer from which an issue was logged to the performance of some or all system resources based on applying the remedy). The program code can identify various attributes and/or parameters in the ML training data 410, which can be stored in one or more contents database 420 (e.g., in a smart action probes collection 317), the program code can utilize various techniques to identify remedies applied to issues reported in log files and whether the issues were mitigated through the execution of the self-healing log remedies. Embodiments of the present invention utilize varying techniques to select attributes (elements, patterns, features, components, etc.), including but not limited to, diffusion mapping, principal component analysis, recursive feature elimination (a brute force approach to selecting attributes), and/or a Random Forest, to select the attributes related to various parts of a log file. The program code can utilize a machine learning algorithm 440 to train the machine learning model 430 (e.g., the algorithms utilized by the program code), including providing weights for the conclusions, so that the program code can train the predictor functions that comprise the machine learning model 430 to generate and/or implement recommended changes in the processes. For example, the machine learning model can revise confidence levels that the intelligent logging semantics 302 assign to certain data in log files 303. The conclusions can also be evaluated by a quality metric 450. By providing a diverse set of ML training data 410 from multiple process runs, the program code trains the machine learning model 430 to identify and weight various attributes (e.g., features, patterns, components) to enable the program code to recommend and/or automatically implements changes to the intelligent logging semantics 302 to improve the efficacy of the self-healing logs (e.g., smart logs 321).

Returning to FIG. 3, data stored in the smart action probes collection 317 can be queried by the self-healed logs tuner 313, which acts as a bridge between logging semantics enhancement and performing continuous corrections/updates in the system. As illustrated in FIG. 3, the self-healed logs tuner 313 can connect directly and/or indirectly with the intelligent logging semantics 302, the intelligent agents (both global 337 and local 317a-317n), and the smart action probes 317, the healed log analytics generator 308, and can implement outputs learned by the system observer and balancer 311. The program code of the self-healed logs tuner 313 can provide these data (learnings) to the intelligent logs semantics 302, enabling the intelligent log semantics 302 to evolve and improve in efficiency, over time, and to adapt as the elements in the technical architecture 300, including but not limited to software applications (which can be provided as microservices), change.

Portions of a development and production lifecycle are included in the technical architecture 300 as the program code of the policy administration point 310 induces the intelligent logging semantics 302 into new and existing pipelines, including a development operations pipeline 307. The self-healed logs tuner 313 can continuously provide (e.g., the development operations pipeline 307) with continuous correction and/or updates by synchronizing with the data provided by the smart action probes 306. Hence, the probes can be deployed as an agent-less configuration to monitor various aspects of the production environment, which in this example is a hybrid cloud environment 331. As will be discussed in greater detail herein, the examples can utilize both local and global agents 337 to execute remedies provided in self-healing logs (smart logs 321) including to provide a local and/or global aggregation and decision-making capability. While a global agent 337 can reside at the policy administration point 301, in some examples herein, in FIG. 3 the global agent 337 is illustrated as residing in the hybrid cloud environment 331 such that it is communicatively couples to all the various resources 348a-348n of the technical architecture 300 (hence, the impacts of program code executed by the global intelligent agent 337 are, as names, global. Meanwhile, the (intelligent) local agents 317a-317n are localized to various resources 348a-348n or groups that comprise the hybrid cloud environment 331.

As aforementioned, although an action can be included in an intelligent log, whether the action should be implemented can be controlled or directed by program code that balances actions with observations within the system. Program code comprising the system observer and balancer 311 observes aspects including centralized logging, distributed tracing, and various other monitoring processes to provide this balance. The analysis by this program code is provided to program code comprising a self-healed analytics generator 308 which assists in implementing log self-healing actions and learnings to provide insights and automation enhancements. Thus, the self-healed analytics generator 308 provides log analysis inputs to the smart action probes 306.

Intelligent agents (e.g., FIG. 2, 204) in the examples herein can be either local or global. If the agents are global 337, they can be found in the technical architecture 300 when the program code converts logs 303 into smart logs 321. Local agents appear as intelligent local agents 317a-317n for various resources 348a-348n of the hybrid cloud environment. Whether local or global, the program code comprising these agents can perform log actions and optimizations when the logs are generated, including at the log generation phase with local and/or distributed agents. In some examples, a log provides its self-healing action by taking into consideration local or global aggregation or correlation within the intelligent logging semantics 302. But in other examples, program code seeks correlation for self-healing of the logged issue from other aspects including from a confidence level generated by the program code based on data available at a local level.

The intelligent logging semantics 302 provide a binary option, in some examples, of either a local or global agent. The agent can aggregate and/or correlate data at the level specified. As illustrated in the hybrid cloud environment 331 in FIG. 3, program code in the examples can sense a local self-healing agent at a local cluster or system level (e.g., hence removing a need to log or track the issue). An example of local self-healing agents are those utilized in various distributed processing platforms. For example, the agents described herein can be utilized to assist in mitigating a microservices access issue inside a cluster of a platform, including but not limited to Kubernetes®. Kubernetes is an open-source, extensible, portable container management platform. Kubernetes is a registered trademark of The Linux Foundation, San Francisco, CA. In Kubernetes, a container has its own central processing unit share, filesystem, process space, memory and more. Containers may share the operating system (OS) among applications due to their relaxed isolation properties; containers are decoupled from the underlying infrastructure; containers are portable across operating system distributions and clouds; and each container is repeatable. Containers are intended to be stateless and immutable—code of a running container is not to be changed; instead, a new container image is built to include the change. In Kubernetes, as well as in certain other platform environments, a microservices access issue emits a log and a corresponding error. The log provides information to heal the issue if the issue reaches a threshold count. When the threshold is reached, the program code executes the remedy (in the log) which includes eliminating the multiple log entries at local node level itself before giving resolved aggregated information to resources outside the node or to the centralized logging system. A local agent in the examples herein can also be utilized to apply the fix (e.g., remedy) at local node or server (e.g., resources 348a-338n) by means of awareness of whether a local node fix, based on the configuration of the technical architecture, is applied at network layer or at an application layer to resolve an issue reported in the log.

In contrast to a local self-healing agents (e.g., local intelligent agents 317a-317n), a global self-healing agent 337, can be utilized for multiple parameter relationships. For example, when an error can be correlated with another parameter or data emitted outside of local environment (e.g., different servers of same cloud or hybrid multi cloud system), a lower log remediation and/or action confidence can be generated by the program code and transmitted to a central or global system where program code comprising an agent determines whether to executed the log action to resolve the error or exception. A global self-healing agent in the examples herein can be a centralized recipient for correlations. A global agent can comprise a server (e.g., during runtime) or a static continuous integration and continuous deployment (CI/CD) pipeline feed (e.g., dev-ops pipeline 307), as two non-limiting examples. The program code of the global agents provides data regarding whether further actions should be taken to resolve an issue, locally and/or globally. Thus, the example of the global intelligent agent 337 can comprise a global remedy in a hybrid cloud environment 331 which triggers a local remedy (e.g., a remedy to aspects of the resources 348a-348n of the hybrid cloud environment 331) (because events correlate in the system).

Returning to FIG. 3, the smart action probes 317 perform actions based on the frequency optimizations of the log. The program code can generate various smart action probes 317 based on issues resolved by the automation (in the self-healing logs). Automations of in the examples herein can be pre-existing, defined by services (e.g., cloud) provider, defined in existing runbooks etc. Program code comprising smart action probes 317 dynamically gather data from different components of a system and/or application. The smart action probes 317 can comprise self-healing and monitoring capabilities, so that they can collect relevant metrics, performance data, and user interactions, in real-time. The smart action probes 317 can comprise machine learning algorithms (which can be continuously tuned based on the performance of the system and its components) which together with the intelligent logging semantics 302, can generate insights into system behavior, identify bottlenecks, and help diagnose issues.

The smart action probes 317 can tune the handling of the logs to generate self-healing logs because the intelligence provided by the smart action probes 317 (in this data-driven approach) enables program code in the self-healing logging system to make informed decisions, optimize performance, and enhance logging and recovery effectiveness. Program code comprising the smart action probes 317 ensures efficient operation and continuous improvement of self-healed logs by delivering valuable data for analysis and proactive problem-solving.

In some examples, the smart action probes 317 extend the intelligent logging semantics 302, the self-healing semantics. The program code can utilize the log semantics and metadata to learn and generate probes. Extending the smart action probes 317 with smart action probes 306 consolidates and increases the self-learning capabilities of the program code (including in generating and applying the self-healed logs tuner 313). The program code can provide tuned models and learned data to the to the dev-ops pipeline 307 (e.g., a CI/CD pipeline) to enforce new semantics and policies. The smart action probes 317 can be implemented in an existing system (e.g., technical architecture 300) via a dev-ops pipeline 307 (e.g., a CI/CD pipeline) or directly by program code updating the intelligent logging semantics 302 (e.g., updating a file directing the format and content of the self-healing logs) including by updating a semantics file in a repository.

Table 2 is an example of intelligent logging semantic 302 (e.g., self-healing log semantics) which have been updated through the use of smart action probes 306. The examples in Table 2 is provided for illustrative purposes only and not to suggest any limitations.

TABLE 2

| Smart Probes | Ignore | Aggregate | Task | Escalate |
|---|---|---|---|---|
| Threshold | 10 | 15 | 17 | 20 |
| RunAutomation | Y | N | Y | N |
| ConvertLogIntoCount | Y | Y | NA | NA |
| Agent | Local | Global | NA | NA |
| ApprovalRequired | N | N | Y | Y |
| Priority | Low | Medium | High | Critical |
| Duration | 1 days | 1 week | NA | Continuous 4 hours |
| Communication | Email | Phone | SMS | App Alert |

Prior to being extended through the probes the semantics included remedy, threshold, RunAutomation, ConvertLogIntoCount, agent, and confidence. The remedies with this extension include ignore, aggregate, task, and escalate, which are provided by the program code, based on the semantics, depending on certain values. With this extension, depending on the threshold met (e.g., 10, 15, 17, or 20), the remedy varies. Additionally, whether the program code automatically executes the memory is based on the remedy, as ignoring and execution of a task can occur automatically but aggregating and escalating the task would depend on additional data. The count discussed above is increased in this example if the remedy is to ignore or to aggregate. According to this extension of the intelligent logging semantics 302, a local agent 317a-317n would address a remedy ignoring a reported issue while a global agent 337 would address a remedy to aggregate responsive to a reported issue. In this example, approval is required for certain of the remedies to be executed, executing the task (and/or transmitting a task to be executed), and escalating an issue, while ignoring or aggregating an issue does not require approval. The smart action probes 306 have extended the intelligent logging semantics 302 to prioritize certain issues based on the remedies involved in self-healing such that ignoring is low priority, aggregating is of a medium priority, executing or triggering execution of a task is high priority, and escalating is critical. In this manner, the pipeline to address issue can be ordered to optimize addressing most critical issues, for example. Arguably, ignoring an issue is the lowest priority ignoring an issue maintains the status quo. This extension also adds a duration for remedies for issues, varying on remedy. Finally, a communication aspect is provided and is specific to the remedy.

Returning to FIG. 3, the healed analytics generator 308 comprises program code that continuously improved and tunes other aspects of the examples herein and can also provide analytics for user visibility and experience. Program code comprising the healed analytics generator 308 obtains raw data as input and from these data, generated output comprising insights and actionable information, which it can provide to the smart action probes 306. Program code of the self-healed analytics generator 308 obtains data from a variety of sources, in this example including the systems observer and balancer 311, and additionally, in some examples, centralized logging, monitoring, and distributed tracing, applies analytical techniques, and produces reports, visualizations, and/or summaries. Program code comprising the systems observer and balancer 311 observes and records events, actions, and/or behaviors within various resources of in the technical architecture 300, including but not limited to software application. As such, the program code comprising the systems observer and balancer 311 maintains equilibrium and fairness in data recording, storage, and analysis for effective log management. The systems observer and balancer 311 can utilize the smart action probes 306 to analyze its output as the program code of the smart action probes 306 comprises one or more machine learning algorithms that learn the efficiencies of the self-healing logs. Meanwhile, consumers of the services provided in the technical architecture 300 can utilize the analytics provided by the self-healed analytics generator 308 to make informed decisions based on understanding patterns, trends, and/or correlations within the data. These decisions can be implemented automatically in some examples herein. Thus, the self-healed analytics generator 308 can be utilized, in some examples herein, for one or more of the following purposes: insight generation, decision support, performance monitoring, predictive analytics, visualizations, benchmarking, continuous improvement, operational efficiency, risk assessment, customer insights.

Returning to FIG. 3, in some examples herein, based on obtaining a log error in a log 303, program code can utilize intelligent logging semantics 302 (as continuously updated based on the activity of the smart action probes 306, to perform a heuristic analysis and to generate a remedy (e.g., a proactive measure) for inclusion in the logs, which is executed by a global 337 intelligent agent or a local 317a-317n intelligent agent. Implementing proactive measures can not only reduce a likelihood of the issue in the log repeating, but can also conserve resources because of automation. Table 3 below provides an analysis of a system into which various aspects of the examples herein are implemented to provide, as a non-limiting example, a view of the benefits of the proactive logging system described herein in mitigating certain issues. Table 3 includes a log entry, as provided by the logs 303, a heuristic analysis, an initial likelihood, a proactive measure or remedy as provided in the smart logs 321, based on the intelligent log semantics 302 (which are continuously tuned by the smart action probes 306), a likelihood of the issue being reduced over time, and an approximation of efforts conserved based on the automation (e.g., self-healing).

TABLE 3

| | | | | | Approx. |
|---|---|---|---|---|---|
| | | | Proactive | Likelihood | Efforts Saved |
| | | Initial | Measure | Reduction | due to |
| | | Likelihood | (Probes/ | (%) over | Automation |
| Log Entry | Heuristic Analysis | (%) | Semantics) | Time | (%) |
| Error: | Repeated | 65% | Network | 20% | 40% |
| Connection | connection losses | | redundancy | reduction in | |
| Lost | indicate network | | enhancement | 6 months | |
| | instability | | | | |
| Info: User | Multiple rapid | 60% | Strengthen | 10% | 25% |
| Login | logins from | | authentication | reduction in | |
| | different locations | | protocols | 4 months | |
| Error: | Frequent timeouts | 75% | Database | 25% | 35% |
| Database | coincide with high | | optimization | reduction in | |
| Timeout | server load | | and load | 5 months | |
| | | | balancing | | |
| Warning: | Consistent memory | 75% | Optimize | 20% | 30% |
| Memory | overload during | | memory usage | reduction in | |
| Overload | high user activity | | in code | 3 months | |
| Info: Unusual | Sudden surge in | 50% | Implement | 15% | 20% |
| Access | access from | | geo-blocking | reduction in | |
| Pattern | unusual geographic | | for IPs | 6 months | |
| | areas | | | | |
| Error: Server | Repeated server | 80% | Scale server | 25% | 45% |
| Unresponsive | unresponsiveness | | resources | reduction in | |
| | might indicate | | vertically | 4 months | |
| | overload | | | | |

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described to best explain various aspects and the practical application, and to enable others of ordinary skill in the art to understand various embodiments with various modifications as are suited to the particular use contemplated.

What is claimed is:

1. A computer-implemented method for proactively mitigating issues, comprising:
generating, by one of more processors, log files comprising records of events in computing system, wherein the events are triggered by issues in the computing system;
converting, by the one or more processors, the log files into smart log files, wherein the smart log files comprise remedies for the issues and execution plans for the remedies, wherein the converting comprises applying intelligent logging semantics derived utilizing a trained machine learning algorithm, to data comprising the log files to derive data comprising the smart log files;
automatically implementing, by the one or more processors, the remedies via the execution plans;
monitoring and retaining, by the one or more processors, results of the execution plans, wherein the results of the execution plan comprise system data relating to performance of resources of the computing system experiencing the issues at the generating;
re-training, by the one or more processors, the machine learning algorithm with the results of the execution plans; and
tuning, by the one or more processors, the intelligent logging semantics with the re-trained machine learning algorithm.

2. The computer-implemented method of claim 1, wherein the tuning comprises expanding the intelligent logging semantics to include additional fields.

3. The computer-implemented method of claim 1, wherein automatically implementing the remedies via the execution plans comprises:
for each execution plan:
determining, by the one or more processors, whether to execute a remedy of the remedies for an issue of the issues on a local resource from which the issue originated or at a global computing system resource, wherein the determining comprising identifying a smart log of the smart logs, when the smart log is related to the issue; and
triggering, by the one or more processors, execution of the remedy based on the smart log.

4. The computer-implemented method of claim 1, wherein monitoring the results of the execution plans comprises:
obtaining, by the one or more processors, the results of the execution plans from local agents monitoring designated resource clusters comprising the computing system and from global agents monitoring the computing system.

5. The computer-implemented method of claim 1, wherein applying intelligent logging semantics comprises:
determining, by the one or more processors, for each execution plan of the execution plan, whether applying each remedy of the remedies involves a local execution or a global execution of the remedy, the determining comprising:
determining, by the one or more processors, based on the intelligent logging semantics, if the executing the remedy utilizes additional context from the global agents; and
based on determining that the executing the remedy utilizes additional context from the global agents, designating a global execution of the remedy in the smart logs.

6. The computer-implemented method of claim 1, wherein applying intelligent logging semantics comprises:
determining, by the one or more processors, for each execution plan of the execution plan, whether applying each remedy of the remedies involves a local execution or a global execution of the remedy, the determining comprising:
determining, by the one or more processors, based on the intelligent logging semantics, if the executing the remedy utilizes additional context from the global agents; and
based on determining that the executing the remedy does not utilize additional context from the global agents, designating a local execution of the remedy in the smart logs.

7. The computer-implemented method of claim 1, wherein automatically implementing the remedies via the execution plans comprises:
for each execution plan:
determining, by the one or more processors, whether implementing the remedy comprises executing the execution plan or ignoring the execution plan, comprising:
predicting, by the one or more processors, based on historical data, impacts on the computing system of executing the execution plan;
balancing, by the one or more processors, the predicted impacts against a current state of the computing system;
based on determining, based on the balancing, that the predicted impacts are favorable, executing the execution plan; and
based on determining, based on the balancing, that the current state is favorable, ignoring the execution plan.

8. The computer-implemented method of claim 1, further comprising:
analyzing, by the one or more processors, the results of the execution plans, to produce computing system analytics;
generating, by the one or more processors, reports based on the analytics; and
transmitting, by the one or more processors, the reports to an administrator of the computing system.

9. The computer-implemented method of claim 1, wherein the re-training comprises:
providing, by the one or more processors, the analytics as an input to the machine learning algorithm.

10. The computer-implemented method of claim 1, wherein the monitoring and the retaining are performed based on controlling probes.

11. The computer-implemented method of claim 10, further comprising:
providing, by the one or more processors, to clusters comprising the computing environment, environment-specific services, via the probes.

12. A computer system for proactively mitigating issues, comprising:
a memory; and
one or more processors in communication with the memory, wherein the computer system is configured to perform a method, said method comprising:
generating, by the one of more processors, log files comprising records of events in a computing system, wherein the events are triggered by issues in the computing system;
converting, by the one or more processors, the log files into smart log files, wherein the smart log files comprise remedies for the issues and execution plans for the remedies, wherein the converting comprises applying intelligent logging semantics derived utilizing a trained machine learning algorithm, to data comprising the log files to derive data comprising the smart log files;
automatically implementing, by the one or more processors, the remedies via the execution plans;
monitoring and retaining, by the one or more processors, results of the execution plans, wherein the results of the execution plan comprise system data relating to performance of resources of the computing system experiencing the issues at the generating;
re-training, by the one or more processors, the machine learning algorithm with the results of the execution plans; and
tuning, by the one or more processors, the intelligent logging semantics with the re-trained machine learning algorithm.

13. The computer system of claim 12, wherein the tuning comprises expanding the intelligent logging semantics to include additional fields.

14. The computer system of claim 12, wherein automatically implementing the remedies via the execution plans comprises:
for each execution plan:
determining, by the one or more processors, whether to execute a remedy of the remedies for an issue of the issues on a local resource from which the issue originated or at a global computing system resource, wherein the determining comprising identifying a smart log of the smart logs, when the smart log is related to the issue; and
triggering, by the one or more processors, execution of the remedy based on the smart log.

15. The computer system of claim 12, wherein monitoring the results of the execution plans comprises:
obtaining, by the one or more processors, the results of the execution plans from local agents monitoring designated resource clusters comprising the computing system and from global agents monitoring the computing system.

16. The computer system of claim 12, wherein applying intelligent logging semantics comprises:
determining, by the one or more processors, for each execution plan of the execution plan, whether applying each remedy of the remedies involves a local execution or a global execution of the remedy, the determining comprising:
determining, by the one or more processors, based on the intelligent logging semantics, if the executing the remedy utilizes additional context from the global agents; and
based on determining that the executing the remedy utilizes additional context from the global agents, designating a global execution of the remedy in the smart logs.

17. The computer system of claim 12, wherein applying intelligent logging semantics comprises:
determining, by the one or more processors, for each execution plan of the execution plan, whether applying each remedy of the remedies involves a local execution or a global execution of the remedy, the determining comprising:
determining, by the one or more processors, based on the intelligent logging semantics, if the executing the remedy utilizes additional context from the global agents; and
based on determining that the executing the remedy does not utilize additional context from the global agents, designating a local execution of the remedy in the smart logs.

18. The computer system of claim 12, wherein automatically implementing the remedies via the execution plans comprises:
for each execution plan:
determining, by the one or more processors, whether implementing the remedy comprises executing the execution plan or ignoring the execution plan, comprising:
predicting, by the one or more processors, based on historical data, impacts on the computing system of executing the execution plan;
balancing, by the one or more processors, the predicted impacts against a current state of the computing system;
based on determining, based on the balancing, that the predicted impacts are favorable, executing the execution plan; and
based on determining, based on the balancing, that the current state is favorable, ignoring the execution plan.

19. The computer system of claim 12, the method further comprising:
analyzing, by the one or more processors, the results of the execution plans, to produce computing system analytics;
generating, by the one or more processors, reports based on the analytics; and
transmitting, by the one or more processors, the reports to an administrator of the computing system.

20. A computer program product for proactively mitigating issues, the computer program product comprising:
one or more computer readable storage media and program instructions collectively stored on the one or more computer readable storage media readable by at least one processing circuit to:
generate log files comprising records of events in a computing system, wherein the events are triggered by issues in the computing system;
convert the log files into smart log files, wherein the smart log files comprise remedies for the issues and execution plans for the remedies, wherein the converting comprises applying intelligent logging semantics derived utilizing a trained machine learning algorithm, to data comprising the log files to derive data comprising the smart log files;
automatically implement the remedies via the execution plans;
monitor and retain results of the execution plans, wherein the results of the execution plan comprise system data relating to performance of resources of the computing system experiencing the issues at the generating;
re-train the machine learning algorithm with the results of the execution plans; and
tune the intelligent logging semantics with the re-trained machine learning algorithm.
